(19) United States
(12) Patent Application Publication
(10) Pub. No.: US 2022/0373381 A1
(43) Pub. Date: Nov. 24, 2022

(54) FLOW REFERENCES

(71) Applicant: TSI Incorporated, Shoreview, MN (US)

(72) Inventors: Anthony Hase, White Bear Township, MN (US); Jeremy Ames, Minneapolis, MN (US); David Castagnetta, Maple Grove, MN (US)

(21) Appl. No.: 17/755,379

(22) PCT Filed: Dec. 11, 2019
(86) PCT No.: PCT/US2019/065615

§ 371 Date: Apr. 27, 2022

Related U.S. Application Data
(60) Provisional application No. 62/926,736, filed on Oct. 28, 2019.

(51) Int. Cl. G01F 25/10; G01F 3/16

(52) U.S. Cl. CPC G01F 25/11; G01F 3/16

(57) ABSTRACT

Disclosed are systems and methods for measuring flowrates. The systems and methods may include passing a fluid from a unit under test into a cavity. The pressure of the fluid within the cavity may be measure and a slidable element located within the cavity may be repositioned to maintain a desired pressure within the cavity. The distance traveled by the slidable element in order to maintain the desired pressure may be determined along with a time for the slidable element to travel the distance. Using the distance traveled by the slidable element, a crosssectional area of the slidable element in contact with the fluid, and the time for the slidable element to travel the distance the volumetric flowrate for the fluid may be determined.

### CLAIM OF PRIORITY

This patent application claims the benefit of priority of U.S. Provisional Patent Application Ser. No. 62/926,736, entitled “FLOW REFERENCES,” filed on Oct. 28, 2019, which is hereby incorporated by reference herein in its entirety.

### BACKGROUND

Devices used in measuring fluid flow rate may need to be calibrated before use. For example, laboratories or settings where research may take place may need instruments that may precisely measure amounts of fluid flowing through a conduit. As a result, before using the instruments they may need to be calibrated. Disclosed herein are systems and methods that may be used to calibrate the instruments.

### SUMMARY

Disclosed are systems and methods for measuring flowrates. The systems and methods may include passing a fluid from a unit under test into a cavity. The pressure of the fluid within the cavity may be measure and a slidable element located within the cavity may be repositioned to maintain a desired pressure within the cavity. The distance traveled by the slidable element in order to maintain the desired pressure may be determined along with a time for the slidable element to travel the distance. Using the distance traveled by the slidable element, a cross-sectional area of the slidable element in contact with the fluid, and the time for the slidable element to travel the distance the volumetric flowrate for the fluid may be determined.

### BRIEF DESCRIPTION OF THE FIGURES

The features and advantages of embodiments disclosed herein, and the manner of attaining them, will become more apparent and the embodiments themselves will be better understood by reference to the following description of embodiments taken in conjunction with the accompanying drawings, wherein:

FIG. 1 shows a schematic of a flow system consistent with embodiments disclosed herein.

FIG. 2 shows a schematic of a flow reference consistent with embodiments disclosed herein.

FIG. 3 shows an example schematic of a controller consistent with embodiments disclosed herein.

FIG. 4 shows an example method consistent with embodiments disclosed herein.

Corresponding reference characters indicate corresponding parts throughout the several views. The disclosure provides illustrative embodiments, and such illustrative embodiments are not to be construed as limiting the scope of the disclosure in any manner.

### DETAILED DESCRIPTION

As disclosed herein, a flow reference may use a slidable element such as a piston, moving within an enclosure, such as a cylinder, as part of fundamental measurements.

As disclosed herein, a flow reference may employ low friction seals and actuators such as, but not limited to, linear actuators, stepper motors, etc., to allow for near friction free movement of a slidable element within an enclosure to measure volumetric flowrates. For example, a piston may be forced through a cylinder using pressure built up from the flow delivered by the device undergoing calibration, sometimes referred to as a unit under test. The actuators may apply a force to the piston that equals the amount of friction between the piston and the cylinder so the piston appears to move in a frictionless manner relative to the flow. Measurements may be taken to determine the sliding friction of the piston so as to reduce the sliding friction to a minimum to achieve a smooth, constant motion of the piston via the actuator. Stated another way, the actuators may apply a force to the piston that is opposite the friction force hindering movement of the piston so that from the flow's perspective, movement of the piston is caused by the flow and not by the actuator.

For example, a powered linear actuator may be used to maintain a smooth constant motion of the piston in a feedback control loop. The piston/cylinder interface may be an industrial, engineered polymer design, such as an O-ring or other lubricant so as to allow the piston to seal to the cylinder without leakage. To overcome the friction of the polymer seal or shear stresses within a fluid seal, the piston may be moved (e.g., pulled or pushed) through use of an actuator, such as a linear actuator or stepper motor, controlled by a feedback loop. The control system may adjust the motion of the piston to maintain a constant pressure in the cylinder. The movement of the piston may be measured using a linear encoder. The time the piston moves may be measured using a timing component of the control system. Using the movement measurement, the time, and the dimensional properties of the cylinder, which are known, the volumetric flowrate of the fluid may be calculated. Furthermore, through measurements of the temperature and pressure of the gas, the mass flowrate may be calculated.

As disclosed herein multiple sized cylinders may be used to measure flows from 0.01 liters per minute to 100 liters per minute to an accuracy of 0.1% reading.

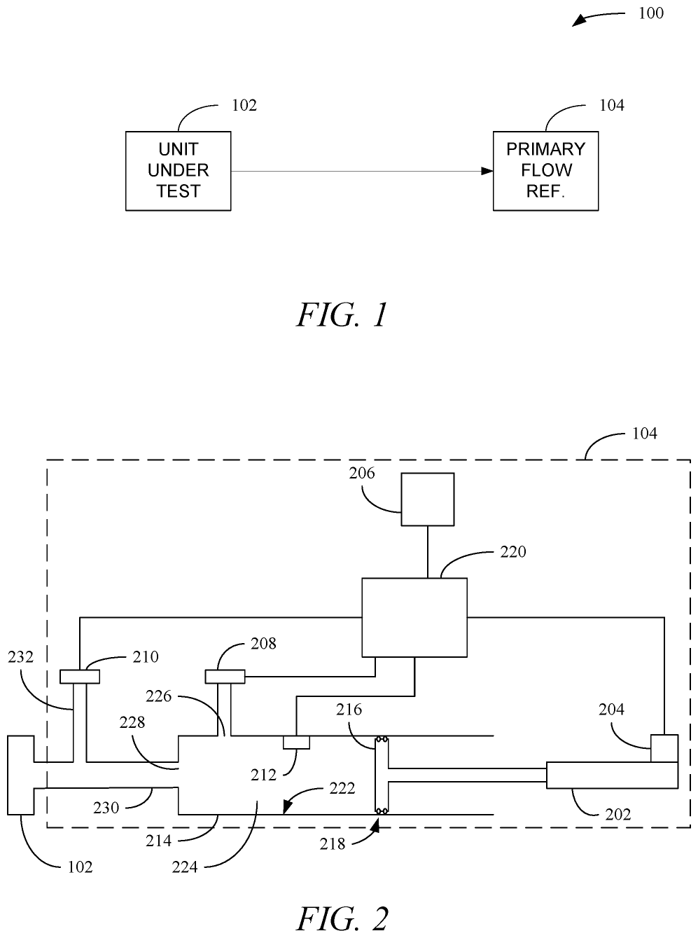

Turning now to the figures, FIG. 1 shows a schematic of a flow system 100 consistent with embodiments disclosed herein. Flow system 100 may include a unit under test 102 and a flow reference 104. As disclosed herein, flow reference 104 may be used to calibrate other flow measurement devices such as unit under test 102. For example, flow reference 104 may be attached downstream of unit under test 102. As disclosed herein, back pressure created by flow reference 104 may be minimized so that flow reference 104 does not negatively impact unit under test 102 during testing. Stated another way, by minimizing the back pressure in the system 100 caused by flow reference 104, flow reference 104 does not place additional load on unit under test 102.

As disclosed herein flow reference 104 may be used to measure volumetric flowrates in series with unit under test 102. In addition, using temperature data and thermodynamic properties, such as the density, of the fluid within system 100, the volumetric flowrates may be converted to mass flowrates. Stated another way, flow reference 104 may be used to measure both volumetric and mass flowrates using primary or fundamental units.

While unit under test 102 has been referenced as having an independent flow source, system 100 may be operated in reverse to calculate a volume of unit under test 102. For example, with unit under test 102 connected to flow reference 104 on one end and unrestricted at the other end, flow reference 104 may be deliver a fluid into unit under test 102. The resulting displacement in the system 100 may be used to calculate the volume of unit under test 102 as disclosed herein.

Turning now to FIG. 2, FIG. 2 shows a schematic of flow reference 104 consistent with embodiments disclosed herein. Flow reference 104 may include an actuator 202, an encoder 204, a timer 206, a first pressure sensor 208, a second pressure sensor 210, a temperature sensor 212, an enclosure 214, a slidable element 216, a seal 218, and a controller 220.

Actuator 202 may be mechanically coupled to slidable element 216. For example, a shaft, such as a worm screw, leadscrews, and other forms of mechanical linkages may be connected to actuator 202 and slidable element 216. The mechanical coupling of slidable element 216 to actuator 202 may result in movement of slidable element 216 upon actuation of actuator 202. Non-limiting examples of actuator 202 include linear actuators, stepper motors, AC or DC motors, etc. Actuator 202 may also include transmissions or other devices that may alter an output of a motor to increase or decrease a mechanical advantage and/or increase or decrease the speed at which slidable element 216 moves per revolution or portion of a revolution of a motor.

Encoder 204 may be electrically coupled to controller 220 and used to track a position or a change in position of slidable element 216. Encoder 204 may produce an analog or digital signal that may be decoded by controller 220 into a distance traveled by slidable element 216. The distance may be a relative or absolute distance. Encoder 204 may be an optical, magnetic, capacitive, inductive, etc. encoder. For example, a shaft or other component of slidable element 216 may include markings that are visible (optically, magnetically, etc.) to encoder 204. As slidable element 216 moves, encoder 204 may count or otherwise track the markings and produce a signal receivable by controller 220. Controller 220 may convert the signal into a distance measurement. Encoder 204 may include discrete position sensors as well as continuous position sensors to monitor the position of slidable element 216.

Timer 206 may be electrically coupled to controller 220 used to track a time that slidable element 216 moves. Timer 206 may be a high precision timer accurate to at least 0.0001 seconds. Timer 206 may be mechanical, electromechanical, electronic, etc. While shown as a separate component, timer 206 may be implemented via software executed by controller 220.

First pressure sensor 208 may be electrically coupled to controller 220 and used to monitor pressure within enclosure 214. Second pressure sensor 210 may be electrically coupled to controller 220 and used to monitor a pressure at an outlet of unit under test 102. First pressure sensor 208 and second pressure sensor 210 may be force collector types, such as, but not limited to, piezoresistive strain gauges, capacitive, electromagnetic, piezoelectric materials, strain-gauges, etc. First pressure sensor 208 and second pressure sensor 210 may be other types, such as, but not limited to, resonant, thermal, ionization, etc. First pressure sensor 208 and second pressure sensor 210 may each transmit a signal to controller 220. Controller 220 may convert the signals to pressure readings as disclosed herein. For example, first pressure sensor 208 and second pressure sensor 210 may be piezoelectric materials that when subjected to an increase in pressure deform and produce a voltage. Controller 220 may used calibration formulas to convert the voltages to pressures. As such, first pressure sensor 208 and second pressure sensor 210 may be located within enclosure 214 as disclosed herein.

Enclosure 214 may include an interior surface 222 that may define a cavity 224. Interior surface 222 may also define a pressure opening 226 and a flow inlet 228. Flow inlet 228 may be connected to a conduit 230 that may connect enclosure 214 to unit under test 102. Second pressure sensor 210 may be located inside conduit 230 or fluidly connected to conduit 230 via a plumbing branch 232 as shown in FIG. 2. First pressure sensor 208 may be located within cavity 224. For example, first pressure sensor 208 may be a piezoelectric material attached to interior surface 222 and may deflect due to pressure exerted by the fluid on interior surface 222.

As disclosed herein, enclosure 214 may be a cylinder of known diameter and length. As a result, movement of slidable element 216 within cavity 224 may result in a volume change that increases or decreases linearly or directly proportional to movement of slidable element 216. In addition to a cylinder, enclosure 214 may have a rectangular cross-sectional area of known width and length. Just as with a cylinder, a rectangular prism formed by enclosure 214 and slidable element 216 having linear dimensions may result in a volume change that increases or decrease linearly or directly proportional to movement of slidable element 216.

As disclosed herein, slidable element 216 may be a piston. Slidable element 216 may have a circular or rectangular cross-sectional area. Slidable element 216 and enclosure 214 may each be constructed of polymers, metals, ceramics, or combinations thereof. For example, enclosure 214 may be constructed of a metal or ceramic and slidable element 216 may be constructed of a polymer. Each of slidable element 216 and enclosure 214 may be impregnated with lubricants and/or include surface treatments to reduce friction between slidable element 216 and interior surface 222. For example, slidable element 216 may be a polymer impregnated with a lubricant and enclosure 216 may be a metal with interior surface 222 having a surface ground roughness of ISO (International Organisation of Standardisation) grade of about N1 to about N12.

The interface between a perimeter surface of slidable element 216 and interior surface 222 may be sealed with seal 218. For example, seal 218 may include one or more O-rings that may be impregnated and/or covered with a lubricant. As disclosed herein, any remaining friction between slidable element 216 and interior surface 222 may be countered by the use of actuator 202.

Seal 218 may also be a mercury seal. A mercury seal may be used to minimize the friction between slidable element 216 and interior surface 222 while simultaneously sealing the interface between a perimeter surface of slidable element 216 and interior surface 222 may be sealed with seal 218. However, mercury poses environmental and health hazards. Thus, using the systems and methods disclosed herein, erratic measurements associated with designed leaking seals and/or mercury seals may be eliminated because actuator 202 may provide a force to counteract the friction forces between the perimeter surface of slidable element 216 and interior surface 222.

Slidable element 216 and enclosure 214 may be manufactured using a variety of manufacturing techniques, such as, but not limited to, machining, injection molding, overmolding, casting, or any combinations thereof. For example, slidable element 216 may be a cast piston that is then overmolded with a polymer to provide surfaces with a lower coefficient of friction. Enclosure 214 may be machined from a billet of a metal such as, but not limited to, aluminum.

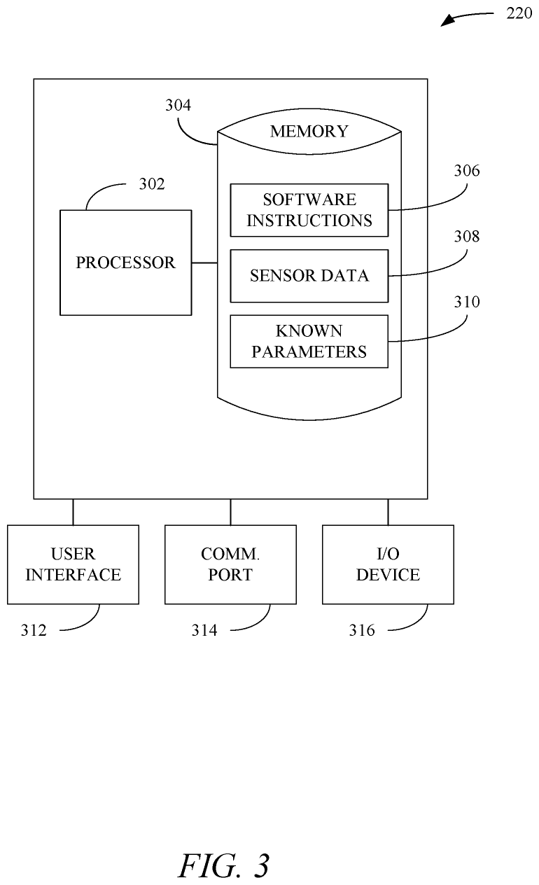

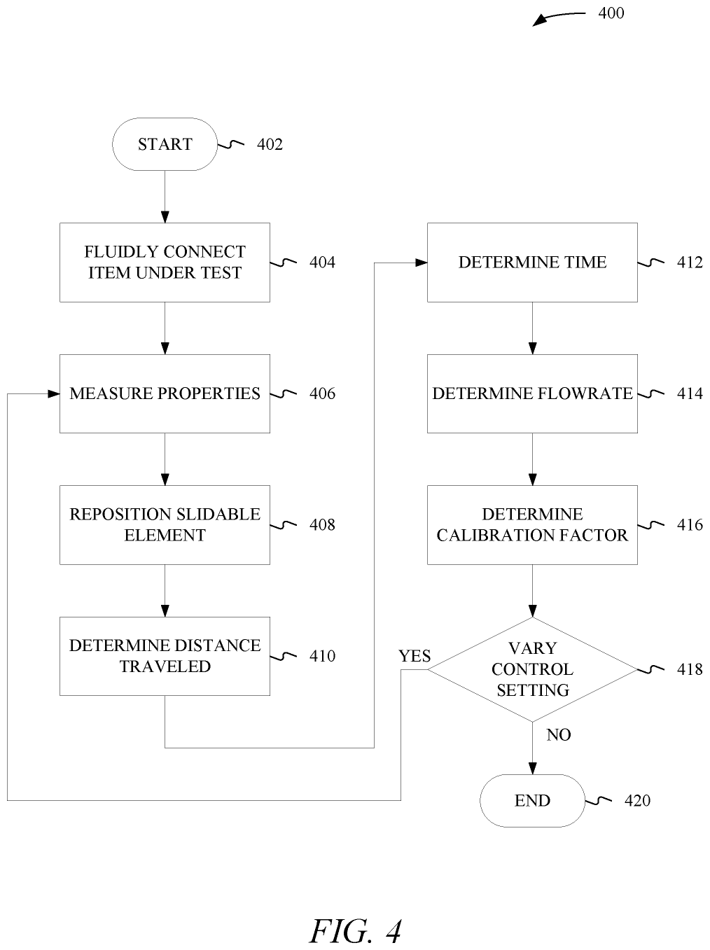

FIG. 3 shows an example schematic of controller 220 consistent with embodiments disclosed herein. Controller 220 may include a processor 302 and a memory 304. Memory 304 may include software instructions 306, sensor data 308, and known parameters 310. While executing on processor 302, software instructions 306 may perform processes for calculating flowrates, including, for example, one or more stages included in a method 400 described below with respect to FIG. 4.

As disclosed herein, sensor data 308 may include one or more parameters for encoder 204, timer 206, first pressure sensor 208, second pressure sensor 210, and temperature sensor 212. For example, each of the previously mentioned signals may output a voltage that is received by processor 302. Processor 302 may access one or more calibration formulas, calibration constants, lookup tables, etc. and use the formulas, constants, lookup tables, etc. to convert the voltages to position, time, pressure, and/or temperature.

Known parameters 310 may include one or more known parameters for system 100 and/or a fluid being used for testing unit under test 102. For example, known parameters 310 may include dimensions for slidable element 216 such as, but not limited to, length and/or radius. Known parameters 310 may also include thermodynamic properties for a fluid, such as, but not limited to, atmospheric air, nitrogen, argon, water, refrigerants, steam, etc. Non-limiting examples of thermodynamic properties include gas constants, density, viscosity, vapor pressure, internal energy, enthalpy, entropy, etc. The thermodynamic properties may be intensive or extensive properties. For example, a known parameter may be the mass of the fluid supplied to system 100. Using sensor data 308, known parameters 310, and inputs from the various sensors, controller 220 may calculate flowrates, such as volumetric flowrates and mass flow rates as described below with respect to FIG. 4 and method 400.

Controller 220 may also include a user interface 312. User interface 312 may allow a user to interact with controller 220 or system 100. For example, using user interface 312, a user may enter sensor data 308, known parameters 310, or program software instructions. Non-limiting examples of user interface 312 may include a keyboard, a display (touchscreen or otherwise), joysticks, etc.

Controller 220 may also include one or more communications ports 314. Communications port 314 may allow controller 220 to communicate with various information sources, such as, but not limited to, encoder 204, timer 206, first pressure sensor 208, second pressure sensor 210, and temperature sensor 212. As disclosed herein, communications port 314 may allow for wired or wireless connections. Non-limiting examples of communications port 314 include, Ethernet cards (wireless or wired), BLUETOOTH® transmitters, receivers, or transceivers, near-field communications hardware modules, serial port and/or parallel port interfaces, universal serial bus (USB) ports, etc.

Controller 220 may also include an input/output (I/O) device 316. I/O device 316 may allow controller 220 to receive and output information. Non-limiting examples of I/O device 316 include, a camera (still or video), encoder 204, timer 206, first pressure sensor 208, second pressure sensor 210, and temperature sensor 212, etc. I/O devices 316 may be connected to controller 220 via communications port 314 or directly without utilizing communications port 314. For example, encoder 204, timer 206, first pressure sensor 208, second pressure sensor 210, and/or temperature sensor 212 may he directly wired to a relay, switch, socket, etc. of controller 220 and thus, may provide a signal directly to a motherboard of controller 220 without the need to utilize communications port 314.

FIG. 4 shows an example method 400 consistent with this disclosure. Method 400 may begin at starting block 402 and proceed to stage 404 where a unit under test, such as unit under test 102, may be fluidly connected to a flow reference, such as flow reference 104. As disclosed herein, fluidly connecting the unit under test to the flow reference may include connecting the unit under test to a conduit or other plumbing that may connect the unit under test to a flow inlet defined by an enclosure, such as enclosure 214. Fluidly connecting the unit under test to the flow reference may include passing a fluid from the unit under test to the flow reference. For example, if the unit under test is a pump, then the pump may pump a liquid or other fluid into the enclosure of the flow reference.

From stage 404, method 400 may proceed to stage 406 where properties may be measured. As disclosed herein, measuring properties may include measuring a pressure. Measuring a pressure may include a controller, such as controller 220, receiving one or more signals from one or more pressure sensors, such as first pressure sensor 208 and/or second pressure sensor 210. The controller may convert the signals to pressures using data such as calibration formulas for pressure sensors. The calibration formula may be stored as sensor data, such as sensor data 308.

Measuring the pressure may include measuring the absolute or gauge pressure within the enclosure of the flow reference. For example, a pressure sensor located within the enclosure or fluidly connected to the enclosure may measure the gauge pressure within the enclosure. The controller may convert the gauge pressure to an absolute pressure using atmospheric pressure, which may be stored as a known parameter, such as known parameters 310. The pressure sensor within the enclosure may also measure the absolute pressure, which may be converted into the gauge pressure if needed.

Measuring a pressure may also include measuring a relative pressure. For example, the pressure within the enclosure may be measured along with the pressure at an exit of the unit under test. The two temperature measurements may be subtracted to determine a pressure differential between the exit of the unit under test and the enclosure.

Also, at stage 406 a temperature may be measured. As disclosed herein, a temperature sensor, such as temperature sensor 212, may be located within the enclosure and may transmit a signal to the controller. The controller may use a calibration formula stored as sensor data 308 to convert the signal to a temperature measurement.

While the various properties are being measured, a slidable element, such a slidable element 216, may be repositioned within the enclosure (stage 408). As disclosed herein, the various properties may be measured as part of a control loop. Thus, as the pressures are being measured, the slidable element may be repositioned to maintain a desired pressure within the enclosure. For example, an actuator, such as actuator 202, may be actuated. Actuation of the actuator may cause the slidable element to be repositioned to maintain a zero gauge pressure or atmospheric pressure during a test. In addition, slidable element may be repositioned to maintain a preset pressure differential between the exit of the unit under test and the enclosure. The preset pressure differential may be a minimized value or a preset value. For example, in a static or slow moving fluid, the preset pressure differential may be zero or close to zero. For a system with where the fluid may be moving faster or the unit under test is located a long distance from the flow reference, the pressure differential may be the head loss expected within the plumbing.

During movement of the slidable element, the position of the slidable element may be tracked and used to determine a distance the slidable element has traveled to achieve the desired pressure (stage 410). For example, using an encoder, such as encoder 204, an initial and final locations of the slidable element may be determined using signals received by the controller from the encoder. Using the initial and final locations, the controller may determine a distance the slidable element traveled to maintain the desired pressure.

During moving of the slidable element, a timer, such as timer 206 or an internal timer to the controller, may track the time interval for which slidable element is moving. For instance, when the slidable element first moves, the controller may note a first time. The controller may note a second time when the slidable element comes to a stop. Using the first and second times, the controller may determine a length of time it took for the slidable element to be repositioned (stage 412).

Once the properties have been measured and the distance and time determined, flowrates may be determined (stage 414). For example, using known parameters of the slidable element, such as a surface area of the slidable element in contact with the fluid within the enclosure, and the distance the slidable element move, a volume, or change in volume, may be calculated using Equation 1.

ΔV=(surface area of slidable element)(distance slidable element traveled) (Equation 1)

Using the change in volume and the time, the volumetric flowrate may be calculated using Equation 2.

$$Volumetric Flowrate = \frac{Δ v}{time} \qquad ( Equation 2 )$$

Using the volumetric flowrate and the temperature of the fluid, the mass flowrate may be determined using Equation 3.

$$Mass Flowrate = \frac{Δ mass}{time} = \frac{( density ) ( Δ V )}{time} \qquad ( Equation 3 )$$

The change in mass is equal to the density of the fluid times the volume of the fluid. Temperature and pressure measurements may be used along with known parameters of the fluid to determine the density. For example, a lookup table and/or an equation that represents the density of the fluid as a function of temperature and pressure may be stored as a known parameter. As a result, when the temperature and pressure measurements are obtained, the controller may utilize the lookup table and/or equation for density to determine a density of the fluid. With the density and volumetric flowrate known, the mass flowrate may be calculated using Equation 3.

Once the flowrates are determined, they may he recorded as a calibration factor for the unit under test (stage 416). Once the calibration factor is recorded a setting for the unit under test may be changed. For example, the unit under test may be an analog thermal flowmeter and the voltage vs. flow curve may be varied. If a setting of the unit under test is changed (decision block 418), method 400 may proceed to stage 406 where properties may be measured and method 400 may proceed as described herein to obtain new calibration factors for each setting of the unit under test. If the unit under test has only one setting, only one setting is being tested, calibration factors have been determined for all of the settings, etc. (decision block 418), the method 400 may terminate at termination block 420.

Using the systems and methods disclosed herein, limitations of currently available flow references are overcome by actively moving the slidable element using an actuator. The systems disclosed herein are able to determine when pressure inside the enclosure has increased and a control loop executed by the controller transmit a signal to the actuator to reposition the slidable element to achieve a desired pressure within the enclosure. For example, a piston may be repositioned to relieve the pressure inside a cylinder to ambient pressure. The actuator may continue to reposition the piston as more fluid enters the cylinder, thereby maintaining the target pressure (e.g., ambient pressure) with a smooth motion on the piston.

As disclosed herein, the systems and methods may be used to measure flow at pressures elevated over ambient or reduced below ambient. To achieve this, the controller may target different pressures within the enclosure.

### EXAMPLES

Example 1 is a flow reference comprising: an enclosure including an interior surface that defines a cavity, a flow inlet; a first pressure sensor in fluid communication with the cavity; a slidable element located within the cavity; an actuator mechanically coupled to the slidable element and arranged to move the slidable element within the cavity; and a computing device electrically coupled to the actuator and the first pressure sensor, the computing device configured to perform actions comprising: receiving a first signal from the first pressure sensor, the first signal corresponding to a pressure within the cavity, and actuating the actuator to reposition the slidable element to maintain a desired pressure within the cavity.

In Example 2, the subject matter of Example 1 optionally includes a seal located between a perimeter surface of the slidable element and the interior surface of the enclosure.

In Example 3, the subject matter of Example 2 optionally includes wherein the seal includes an O-ring.

In Example 4, the subject matter of any one or more of Examples 2-3 optionally include wherein the seal includes a mercury seal.

In Example 5, the subject matter of any one or more of Examples 1-4 optionally include wherein the actuator is a stepper motor.

In Example 6, the subject matter of any one or more of Examples 1-5 optionally include wherein the actuator is a linear actuator.

In Example 7, the subject matter of any one or more of Examples 1-6 optionally include an encoder electrically coupled to the computing device, the encoder configured to transmit an encoder signal to the computing device corresponding to a position of the slidable element.

In Example 8, the subject matter of any one or more of Examples 1-7 optionally include wherein the actions further comprise calculating a volumetric flowrate of a unit under test based at least on actuation of the actuator.

In Example 9, the subject matter of Example 8 optionally includes a temperature sensor electrically coupled to the computing device, wherein the actions further comprise:

receiving a temperature signal from the temperature sensor, the temperature signal corresponding to a temperature of a fluid within the cavity; and calculating a mass flowrate based at least on the temperature of the fluid, the pressure within the cavity, and the mass flow rate.

In Example 10, the subject matter of any one or more of Examples 1-9 optionally include a temperature sensor electrically coupled to the computing device, wherein the actions further comprise: receiving a temperature signal from the temperature sensor, the temperature signal corresponding to a temperature of a fluid within the cavity; and calculating a mass flowrate based at least on the temperature of the fluid, the pressure within the cavity, and actuation of the actuator.

In Example 11, the subject matter of any one or more of Examples 1-10 optionally include a timer electrically coupled to the computing device.

In Example 12, the subject matter of any one or more of Examples 1-11 optionally include a second pressure sensor electrically coupled to the computing device, wherein the actions further comprise receiving a second signal from the second pressure sensor, and wherein the desired pressure is a differential pressure between the first pressure sensor and the second pressure sensor.

In Example 13, the subject matter of any o e or more of Examples 1-12 optionally include wherein the enclosure is a cylinder.

In Example 14, the subject matter of any one or more of Examples 1-13 optionally include wherein the slidable element is a piston.

In Example 15, the subject matter of any one or more of Examples 1-14 optionally include wherein the desired pressure is an absolute pressure.

Example 16 is a flow reference comprising: a cylinder including an interior surface that defines a cavity and a flow inlet; a first pressure sensor in fluid communication with the cavity; a piston located within the cavity; an actuator mechanically coupled to the piston and arranged to move the piston in a linear direction within the cavity; and a computing device electrically coupled to the actuator and the first pressure sensor, the computing device configured to perform actions comprising: receiving a first signal from the first pressure sensor, the first signal corresponding to a pressure within the cavity, actuating the actuator to reposition the piston to maintain a desired pressure within the cavity, determining a distance traveled by the piston due to actuation of the actuator, determining a time for the piston to travel the distance, and determining a volumetric flowrate of a fluid entering the flow inlet based on the distance traveled by the piston, a cross-sectional area of the piston in contact with the fluid, and the time for the piston to travel the distance.

In Example 17, the subject matter of Example 16 optionally includes an encoder electrically coupled to the computing device, the encoder configured to transmit an encoder signal to the computing device corresponding to a position of the slidable element, wherein the actuator is a linear actuator, and wherein determining the distance traveled by the piston includes utilizing the encoder signal to determine the distance traveled.

In Example 18, the subject matter of any one or more of Examples 16-17 optionally include wherein the actuator is a stepper motor and determining the distance traveled by the piston includes counting a number of steps taken by the stepper motor.

In Example 19, the subject matter of any one or more of Examples 16-18 optionally include a timer electrically coupled to the computing device, the timer used for determining the time for the piston to travel the distance.

In Example 20, the subject matter of any one or more of Examples 16-19 optionally include a second pressure sensor electrically coupled to the computing device, wherein the actions further comprise receiving a second signal from the second pressure sensor, and wherein the desired pressure is a differential pressure between the first pressure sensor and the second pressure sensor.

In Example 21, the subject matter of any one or more of Examples 16-20 optionally include a temperature sensor located within the cavity and electrically coupled to the computing device, wherein the actions further comprise: receiving a temperature signal from the temperature sensor, the temperature signal corresponding to a temperature of the fluid within the cavity; and calculating a mass flowrate based on the temperature and the volumetric flowrate of the fluid.

In Example 22, the subject matter of any one or more of Examples 16-21 optionally include a seal located between a perimeter surface of the piston and the interior surface of the enclosure.

In Example 23, the subject matter of Example 22 optionally includes wherein the seal includes an O-ring.

In Example 24, the subject matter of any one or more of Examples 22-23 optionally include wherein the seal includes a mercury seal.

Example 25 is a method for measuring a volumetric flowrate of a flow produced by a unit under test, the method comprising: fluidly connecting the unit under test to a flow inlet of an enclosure, the enclosure defining a cavity and the flow inlet; measuring a pressure of a fluid within the cavity; repositioning a slidable element located within the cavity to maintain a desired pressure within the cavity; determining a distance traveled by the slidable element in order to maintain the desired pressure; determining a time for the slidable element to travel the distance; and determining the volumetric flowrate of the fluid entering the cavity based on the distance traveled by the slidable element, a cross-sectional area of the slidable element in contact with the fluid, and the time for the slidable element to travel the distance.

In Example 26, the subject matter of any one or more of Examples 24-25 optionally include wherein determining the time for the slidable element to travel the distance includes receiving the time from an external timer.

In Example 27, the subject matter of any one or more of Examples 24-26 optionally include wherein determining the distance traveled by the slidable element includes receiving a signal from an encoder, the signal corresponding to a position or a change in position of the slidable element.

In Example 28, the subject matter of any one or more of Examples 24-27 optionally include wherein repositioning the slidable element includes actuating a stepper motor mechanically coupled to the slidable element, and determining the distance traveled by the slidable element includes counting a number of steps taken by the stepper motor, each step corresponding to a known distance traveled by the slidable element.

In Example 29, the subject matter of any one or more of Examples 24-28 optionally include measuring a pressure at an outlet of the unit under test, wherein repositioning the slidable element located within the cavity to maintain the desired pressure within the cavity includes repositioning the slidable element to maintain a minimized differential pressure between the pressure at the outlet of the unit under test and the pressure within the cavity.

In Example 30, the subject matter of any one or more of Examples 24-29 optionally include measuring a temperature of the fluid within the cavity; and calculating a mass flowrate based on the temperature and the volumetric flowrate of the fluid.

In Example 31, the subject matter of any one or more of Examples 24-30 optionally include varying a control setting of the unit under test; determining a volumetric flowrate for each control setting; creating a calibration factor for the unit under test as a function of the control setting.

In Example 23, the flow references or methods of any one of or any combination of Examples 1-31 is optionally configured such that all elements or options recited are available to use or select from.

The detailed description refers to the accompanying drawings. Wherever possible, the same reference numbers are used in the drawings and the following description to refer to the same or similar elements. While embodiments and examples are described, modifications, adaptations, and other implementations are possible. For example, substitutions, additions, or modifications may be made to the elements and stages illustrated in the drawings, and the systems and methods described herein may be modified by substituting, reordering, or adding stages to the disclosed methods or elements to the discloses systems. Accordingly, the detailed description does not limit this disclosure. Instead, the proper scope of any invention disclosed herein is defined by the appended claims.

It will be readily understood to those skilled in the art that various other changes in the details, material, and arrangements of the parts and method stages which have been described and illustrated in order to explain the nature of the disclosed subject matter may be made without departing from the principles and scope of the disclosed subject matter as expressed in the subjoined claims.

1.-31. (canceled)

32. A flow reference comprising:
an enclosure including an interior surface that defines a cavity, a flow inlet;
a first pressure sensor in fluid communication with the cavity;
a slidable element located within the cavity;
an actuator mechanically coupled to the slidable element and arranged to move the slidable element within the cavity; and
a computing device electrically coupled to the actuator and the first pressure sensor, the computing device configured to perform actions comprising:
receiving a first signal from the first pressure sensor, the first signal corresponding to a pressure within the cavity, and
actuating the actuator to reposition the slidable element to maintain a desired pressure within the cavity.

33. The flow reference of claim 32, further comprising a seal located between a perimeter surface of the slidable element and the interior surface of the enclosure.

34. The flow reference of claim 33, wherein the seal includes an O-ring or a mercury seal.

35. The flow reference of claim 32, wherein the actuator is a stepper motor or a linear actuator.

36. The flow reference of claim 32, further comprising an encoder electrically coupled to the computing device, the encoder configured to transmit an encoder signal to the computing device corresponding to a position of the slidable element.

37. The flow reference of claim 32, wherein the actions further comprise calculating a volumetric flowrate of a unit under test based at least on actuation of the actuator.

38. The flow reference of claim 37, further comprising a temperature sensor electrically coupled to the computing device, wherein the actions further comprise:
receiving a temperature signal from the temperature sensor, the temperature signal corresponding to a temperature of a fluid within the cavity; and
calculating a mass flowrate based at least on the temperature of the fluid, the pressure within the cavity, and the mass flow rate.

39. The flow reference of claim 32, further comprising a temperature sensor electrically coupled to the computing device, wherein the actions further comprise:
receiving a temperature signal from the temperature sensor, the temperature signal corresponding to a temperature of a fluid within the cavity; and
calculating a mass flowrate based at least on the temperature of the fluid, the pressure within the cavity, and a distance traveled by the piston.

40. The flow reference of claim 32, further comprising a tinier electrically coupled to the computing device.

41. The flow reference of claim 32, further comprising a second pressure sensor electrically coupled to the computing device,
wherein the actions further comprise receiving a second signal from the second pressure sensor, and
wherein the desired pressure is a differential pressure between the first pressure sensor and the second pressure sensor.

42. A flow reference comprising:
a cylinder including an interior surface that defines a cavity and a flow inlet;
a first pressure sensor in fluid communication with the cavity;
a piston located within the cavity;
an actuator mechanically coupled to the piston and arranged to move the piston in a linear direction within the cavity; and
a computing device electrically coupled to the actuator and the first pressure sensor, the computing device configured to perform actions comprising:
receiving a first signal from the first pressure sensor, the first signal corresponding to a pressure within the cavity,
actuating the actuator to reposition the piston to maintain a desired pressure within the cavity,
determining a distance traveled by the piston due to actuation of the actuator,
determining a time for the piston to travel the distance, and
determining a volumetric flowrate of a fluid entering the flow inlet based on the distance traveled by the piston, a cross-sectional area of the piston in contact with the fluid, and the time for the piston to travel the distance.

43. The flow reference of claim 42, further comprising an encoder electrically coupled to the computing device, the encoder configured to transmit an encoder signal to the computing device corresponding to a position of the slidable element,
wherein the actuator is a linear actuator, and
wherein determining the distance traveled by e piston includes utilizing the encoder signal to determine the distance traveled.

44. The flow reference of claim 42, wherein the actuator is driven by a stepper motor and determining the distance traveled by the piston includes counting a number of steps taken by the stepper motor.

45. The flow reference of claim 42, further comprising a timer electrically coupled to the computing device, the timer used for determining the time for the piston to travel the distance.

46. The flow reference of claim 42, further comprising a second pressure sensor electrically coupled to the computing device,
wherein the actions further comprise receiving a second signal from the second pressure sensor, and
wherein the desired pressure is a differential pressure between the first pressure sensor and the second pressure sensor.

47. The flow reference of claim 42, further comprising a temperature sensor located within the cavity and electrically coupled to the computing device, wherein the actions further comprise:
receiving a temperature signal from the temperature sensor, the temperature signal corresponding to a temperature of the fluid within the cavity; and
calculating a mass flowrate based on the temperature and the volumetric flowrate of the fluid.

48. The flow reference of claim 42, further comprising a seal located between a perimeter surface of the piston and the interior surface of the enclosure.

49. A method for measuring a volumetric flowrate of a flow produced by a unit under test, the method comprising:
fluidly connecting the unit under test to a flow inlet of an enclosure, the enclosure defining a cavity and the flow inlet;
measuring a pressure of a fluid within the cavity;
repositioning a slidable element located within the cavity to maintain a desired pressure within the cavity;
determining a distance traveled by the slidable element in order to maintain the desired pressure;
determining a time for the slidable element to travel the distance; and
determining the volumetric flowrate of the fluid entering the cavity based on the distance traveled by the slidable element, a cross-sectional area of the slidable element in contact with the fluid, and the time for the slidable element to travel the distance.

50. The method of claim 49, further comprising:
measuring a temperature of the fluid within the cavity; and
calculating a mass flowrate based on the temperature and the volumetric flowrate of the fluid.

51. The method of claim 49, further comprising:
varying a control setting of the unit under test;
determining a volumetric flowrate for each control setting;
creating a calibration factor for the unit under test as a function of the control setting.
